(19) United States
(12) Patent Application Publication
(10) Pub. No.: US 2011/0314714 A1
(43) Pub. Date: Dec. 29, 2011

(54) MERCHANDISING AND MERCHANT DISPLAYS FOR STATIONARY

(76) Inventors: Michelle Baxendale, Brunswick, OH (US); Richard Hall, Mayfield, OH (US); Wendy Jaroscak, Olmsted Falls, OH (US); Jessica Weese, Rocky River, OH (US); Jennifer Davila, Lakewood, OH (US)

(21) Appl. No.: 13/169,301

(22) Filed: Jun. 27, 2011

Related U.S. Application Data
(60) Provisional application No. 61/359,528, filed on Jun. 29, 2010.

(51) Int. Cl. G09F 15/00; A47F 1/04; A47F 7/00; G09F 15/02

(52) U.S. Cl. 40/606.03; 211/59.2; 211/59.1

(57) ABSTRACT

A retail merchandising display for stationery having a main display panel for the display of various types of stationery products that are arranged on the display according to color, design, theme, quality, price or a combination thereof for quick and easy location by a consumer. Each product may be placed into a category such as invitations or thank you cards and arranged within that category according to color, theme, design, price, or a combination thereof. Products may also be arranged across categories according to color, theme, design or price. Product packaging may be indicative of the product price pint and may further include color coding for quick identification of the product category. Color coordinated signage may also be used to further associate product types or categories.

### RELATED APPLICATIONS

This application claims priority to U.S. Provisional Patent Application Ser. No. 61/359,528, filed on Jun. 29, 2010, which is incorporated herein in its entirety.

### FIELD OF THE INVENTION

The present invention is in the field of merchandise fixtures and more specifically retail fixtures for stationery products.

### BACKGROUND OF THE INVENTION

Traditional retail displays for paper and stationery products typically present the products in a standardized arrangement which makes it difficult or time consuming for a consumer to locate a particular product. The standard industry practice is to have each particular category of item displayed under a single heading, such as invitations, blank notes, etc. While a consumer is directed to a particular category of product, he or she must search through several items to locate the particular color, theme or design required. Also, products in the same category each contain different pricing levels which makes it difficult for a consumer to recognize the price level or quality of the item without having to find and remove each item from the display and search for the pricing information. There is a need in this area of retail for a novel way to organize and display stationery and paper products that is conducive to a quick and easy shopping experience while also creating a visually appealing display that guides consumers to a desired product while highlighting related and/or coordinating products.

### SUMMARY OF THE INVENTION

The merchandising display for stationery of the present disclosure and related inventions includes at least one pair of spaced apart upright members and at least one display panel spanning between and supported by the at least one pair of spaced apart upright members. A plurality of shelves and hanger brackets are removably attached to the display panel for displaying a plurality of stationery products. Each of the stationery products is arranged on the display panel according to color, design, theme, quality, price or a combination thereof

In accordance with one aspect of the present disclosure and related inventions, there is provided a retail merchandise display for stationery products which has at least one pair of spaced apart upright members; at least one display panel spanning between and supported by the at least one pair of spaced apart upright members; a plurality of display fixtures removably attached to the at least one display panel; a plurality of stationery products displayed upon the plurality of display fixtures in horizontal rows and vertical columns, the plurality of stationery products arranged into at least three groups arranged by type of stationery product and within each of the at least three groups, the plurality of stationery products are further grouped and arranged by occasion, and wherein at least one horizontal row of stationery products are coordinated by design theme and at least one vertical column of stationery products are coordinated by color.

In accordance with another aspect of the present disclosure and related inventions, there is provided a retail merchandise display for stationery which has a merchandise display having a display panel with fixtures supporting different types of stationery products, each type of stationery product being grouped together in different areas on the display panel, whereby a first area on the display panel contains a first type of stationery product, a second area on the display panel contains a second type of stationery product and a third area on the display panel contains a third type of stationery product; a display sign located above each area of the display panel which indicates the type of product in that area, wherein the stationery products in each area contain stationery product packaging which is color coordinated with the display sign located above that area.

These and other aspects of the present disclosure and related inventions are further described herein with reference to the accompanying drawing figures.

### DESCRIPTION OF THE DRAWINGS

FIG. 1 is a front view of the merchandising and merchant displays for stationery of the present invention.

FIG. 2 is a front view of exemplary color coded packaging and corresponding signage.

FIG. 3 is a front view of a stationery display showing arrangement of product by color and/or design theme.

FIG. 4 is a front view of a stationery display showing coordinated products located at the same location at opposite sides of the display.

### DETAILED DESCRIPTION OF PREFERRED AND ALTERNATE EMBODIMENTS

The retail merchandising display of the present invention combines a unique product packaging method with a novel product placement strategy to create a merchandising display for stationery that aids the consumer in quickly finding desired stationery products while also potentially increasing sales for the retailer by highlighting related products the consumer may also wish to purchase. The display creates a convenient, visually appealing shopping experience. As used herein the term “stationery” refers to paper products such as writing paper, thank you cards, blank note cards, invitations and the like.

A representative retail merchandising display according to the present invention includes a generally upright frame structure having two spaced apart frame members and a display panel which extends between the two spaced apart frame members and serves as a structural backing for the attachment of merchandise hangers or other such fasteners. Each of the two spaced apart frame members may contain a plurality of slots or openings thereon configured for insertion of shelving brackets or other fasteners that may be removably attached. The display panel may contain a plurality of pre-positioned holes thereon that can be used to support a plurality of display fixtures such as hanger hardware and the like. One type of display panel which can be used in connection with the display is known as a slat wall panel, which has an array of horizontally disposed grooves in which different types of bracketry and hanging devices are engaged for the suspension of products therefrom. Other types of display panels that can be used include, but are not limited to, peg-board or custom-made panels with engagements for multiple types of product hanger brackets.

The placement of the product on the retail merchandising display is configured to allow quick and easy navigation by a consumer wishing to locate a particular type of product. The stationery and/or any type of paper or sheet material products may be arranged according to theme or format (e.g., thank you notes, blank note cards, invitations, etc., all of which and variations thereof are referred to herein as “stationery”), by design type (e.g., graphic, watercolor, photographs), by color of the product, or by quality of the product (e.g., good, better, best). As used herein the term “coordinated by color”, “color coordinated”, “arranged according to color”, or “grouped by color” are intended to include not only items of the same exact color but colors that are in the same color palette or color family, such as pastel colors, warm tones, cool tones, earth tones, and other such related color schemes. The terms “design theme”, “design type” or “design pattern” are intended to indicate designs which are related by some visually distinct aspect or arrangement of printed indicia. Examples of design themes include, but are not limited to, floral, animals, geometric shapes, feminine, masculine, photographs and watercolors.

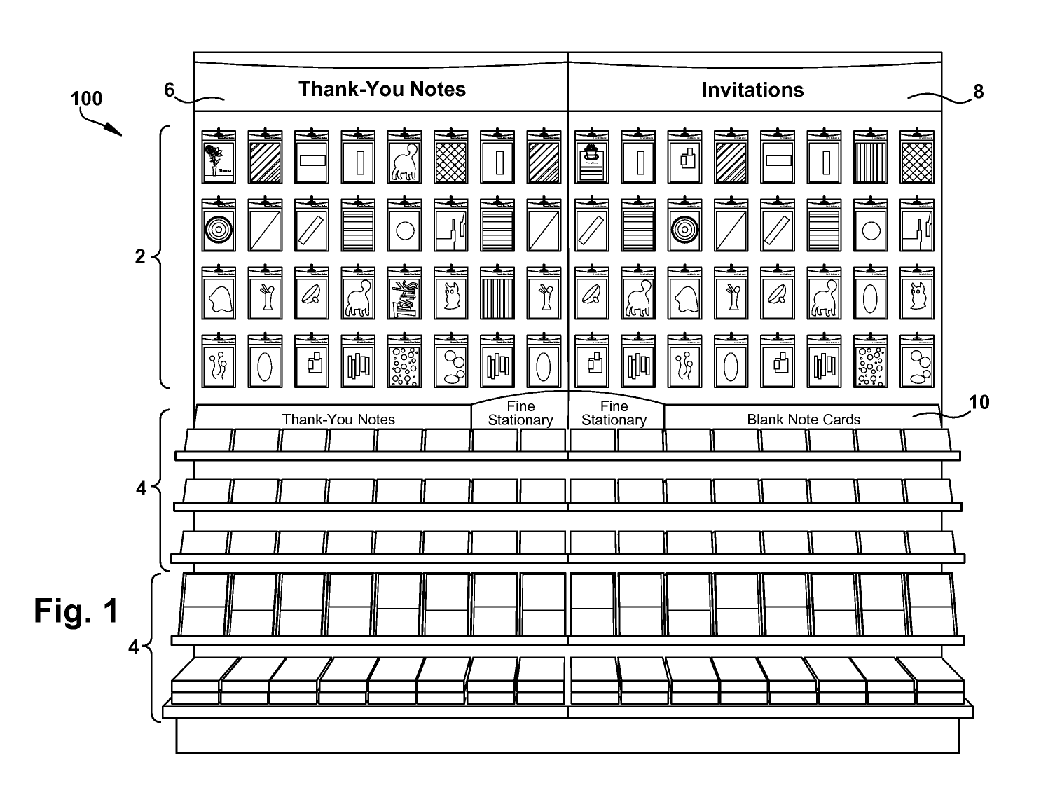

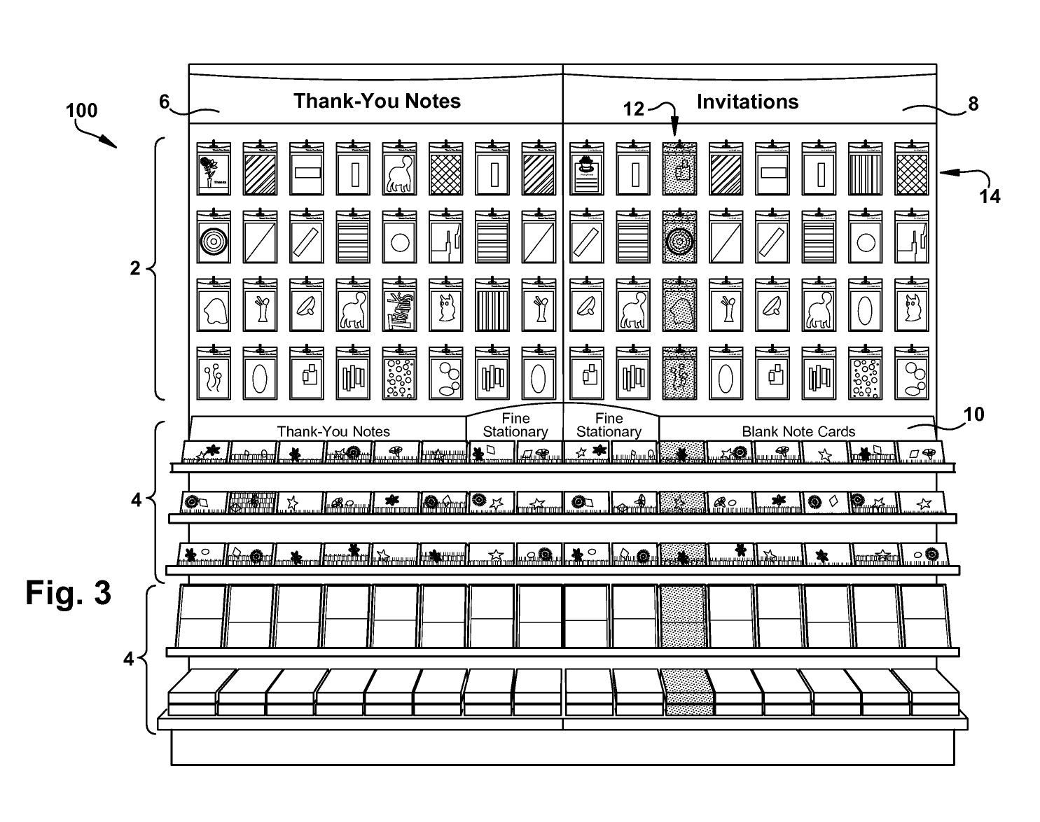

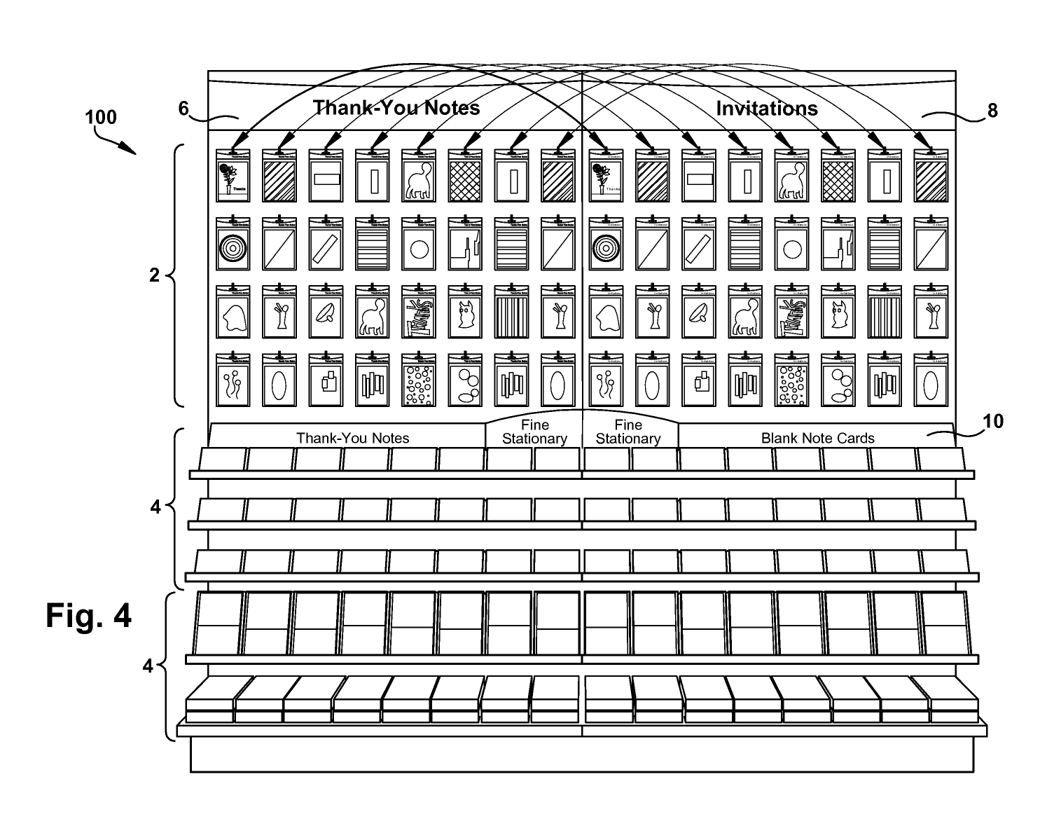

In a preferred embodiment, shown in FIG. 1, the stationery products are displayed using a combination of hanger brackets 2 and horizontal shelving 4. The products displayed on the hanger brackets 2 are packaged with a hangtag or with holes in the top of the packaging so that they may be suspended from the hanger brackets 2. Multiple packages of the same stationery product may be contained on each hanger bracket 2. The products are arranged across the display 100 in generally horizontal rows and columns. The products may be arranged upon the display 100 first by theme or format. For example, one section of the display may contain thank you notes 6 while another section displays invitations 8. Across theme or format categories, products may be arranged horizontally by design type and vertically by color or vice versa, as shown in FIG. 3. For example, products from the various categories, such as invitations 8 and blank note cards 10 may be arranged such that they are vertically oriented by color (indicated by reference number 12). The same basic color theme is used throughout the products, across categories, in each vertical column. Cross category products may also be arranged such that they are horizontally oriented by design style (indicated by reference number 14). For example, all products (invitations, thank you notes, note cards) in the same horizontal row have the same design style, such as a floral design or geometric design pattern. These products can simultaneously be arranged vertically by color and horizontally by design theme. This organization method allows consumers to focus on a specific area of the display to find the desired product in the desired color or design theme. The products may also be arranged by the quality of the product, such as good, better and best categories. The good quality products may be contained in an upper region of the display, followed by the better quality products which may be contained in a middle section of the display and then the best quality products may be contained in a lower region of the display. Another way in which the product placement aids in the ease of locating desired products, is that for all products being suspended from a hangtag, a related item in the same design or theme is located in a corresponding location at the opposite side of the display 100, as shown in FIG. 4. For example, if a set of pink birthday invitations are located in the upper left corner of the display, then a coordinating set of pink birthday thank you notes are located in the upper right corner of the display 100. For further illustration, if a set of silver wedding invitations is placed to the right of the pink birthday invitations on the upper left corner of the display 100, then a corresponding set of silver wedding thank you notes are located to the left of the pink birthday thank you notes on the upper right corner of the display 100. Additionally, specially promoted products or new product lines may be highlighted by being located at the center of the display 100. Products within each category may also be grouped by occasion such as bridal, kids, baby, wedding, etc. While a preferred embodiment of the retail merchandising display 100 of the present invention has been described herein as utilizing hanger brackets 2 and shelving 4, any type and combination of product display devices may be used and in no way is the present invention intended to be limited the foregoing examples.

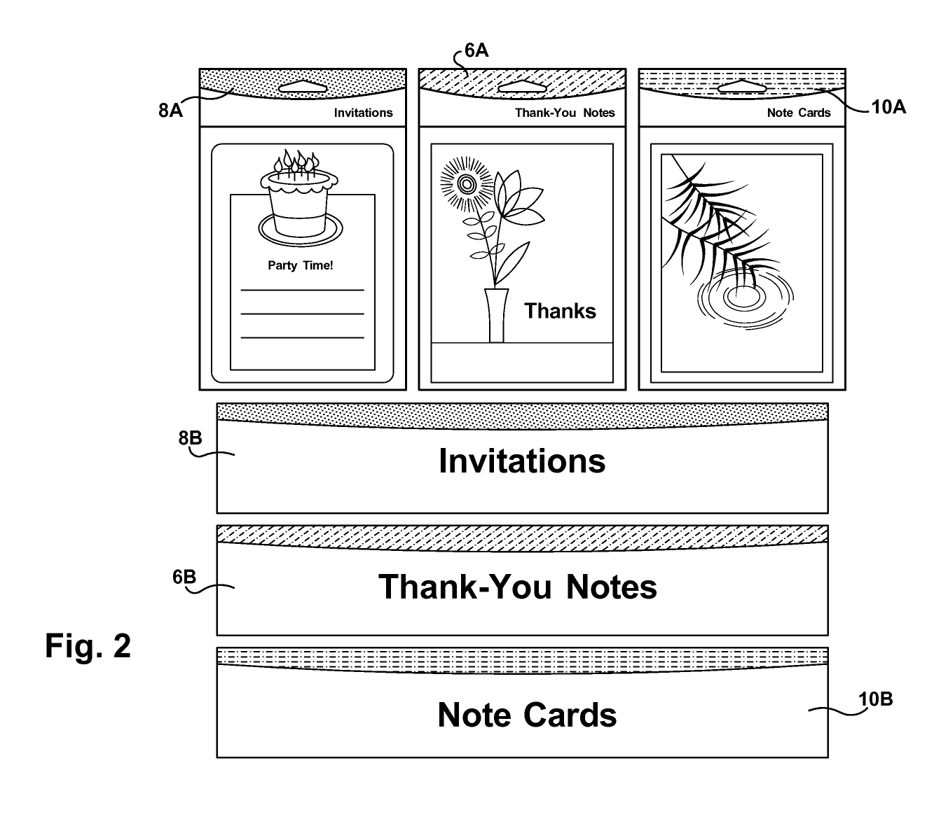

In addition to product placement, product packaging is also used to create a more intuitive display where consumers may quickly find a particular item. As mentioned above, products may be categorized according to product quality or price. Good quality products are the lowest priced products and are typically packaged or contained in polybags which are sealed with a package header or hangtag. These products may be suspended from hanger brackets engaged with the display panel. A plurality of polybags may be suspended from a single hanger bracket. Each of the package headers or hangtags may be colored by product type, as shown in FIG. 2. For example, all invitations have a yellow hangtag 8A, while all thank you notes have a green hangtag 6A, and all note cards have a blue hangtag 10A. Display signage will also follow the color coordinated packaging so that the sign above the invitations is yellow 8B, the sign above the thank you notes is green 6B, and the sign above the note cards is blue 10B. This allows consumers to quickly identify the category of items within which he/she wishes to purchase a product. Better quality products are typically greater in price than the good quality products but less than the best quality products. Better quality products may be contained or packaged in color coordinated boxes with vinyl covers. Best quality or highest priced products are contained in high quality stationery boxes with vinyl covers. The better and best quality products are typically arranged horizontally along a plurality of angled shelves so that the front face of each product is easily viewed by an approaching consumer. While the product packaging has been described herein as polybags and boxes with vinyl covers, any type of stationery packaging may be used and remain within the intended scope of the present invention.

The product placement and packaging work in combination to provide the user with an easily accessible merchandise display from which a desired product may be quickly located and wherein corresponding or related items are highlighted or made apparent to the consumer. For example, if a consumer approaches the display 100 in search of invitations to a female child's birthday party, the consumer may first locate the region of the display that contains invitations 8 by looking for the color coordinated signage 8B and packaging 8A. Once the invitations 8 have been located, the invitations for a female child may be quickly identified by the arrangement of products by color, wherein the consumer would typically find pink or pastel colors. After the consumer has selected a particular set of invitations 8, he/she may look to the same location on the opposite side of the display to find coordinating thank you notes 6. The quick and easy method for finding related products may induce or encourage a consumer to purchase additional products that he/she did not originally intend on making

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A retail merchandise display for stationery products comprising:
at least one pair of spaced apart upright members;
at least one display panel spanning between and supported by the at least one pair of spaced apart upright members;
a plurality of display fixtures removably attached to the at least one display panel;
a plurality of stationery products displayed upon the plurality of display fixtures in horizontal rows and vertical columns, the plurality of stationery products arranged into at least three groups arranged by type of stationery product and within each of the at least three groups, the plurality of stationery products are further grouped and arranged by occasion;
wherein at least one horizontal row of stationery products are coordinated by design theme and at least one vertical column of stationery products are coordinated by color.

2. The retail merchandise display of claim 1, wherein the display fixtures include hanger hooks and horizontal shelves.

3. The retail merchandise display of claim 1, wherein the at least three groups of stationery products include invitations, thank you notes and note cards.

4. The retail merchandise display of claim 1 further including three or more display signs which are removably attached to the at least one display panel, and which indicate the type of product displayed below each of the three or more display signs.

5. The retail merchandise display of claim 1, further comprising a group of stationery products located at the center of the at least one display panel which includes new products.

6. The retail merchandise display of claim 1, wherein a first product in a first group of stationery products and a second product in a second group of stationery products are coordinated by color, design theme and occasion and are located in the same location on opposite sides of the at least one display panel.

7. A retail merchandise display for stationery comprising:
a merchandise display having a display panel with fixtures supporting different types of stationery products, each type of stationery product being grouped together in different areas on the display panel, whereby a first area on the display panel contains a first type of stationery product, a second area on the display panel contains a second type of stationery product and a third area on the display panel contains a third type of stationery product;
a display sign located above each area of the display panel which indicates the type of product in that area;
wherein the stationery products in each area contain stationery product packaging which is color coordinated with the display sign located above that area.

8. The retail merchandise display of claim 7, wherein the first area contains invitations, the second area contains thank you notes and the third area contains blank note cards.

9. The retail merchandise display of claim 7, wherein the first, second and third areas are further grouped by occasion.

10. The retail merchandise display of claim 7, wherein the stationery products are arranged on the display in horizontal rows and vertical columns.

11. The retail merchandise display of claim 10, wherein at least one horizontal row is coordinated by design theme.

12. The retail merchandise display of claim 10, wherein at least one vertical column is color coordinated.

13. The retail merchandise display of claim 7, wherein at least one product in the first area corresponds in color and design theme to at least one product in the second area.

14. The retail merchandise display of claim 7, wherein the stationery products each have product packaging which corresponds with the quality or price of the stationery product.

15. A retail merchandise display for stationery comprising:
a merchandise display having two spaced apart upright members and at least one display panel therebetween, the display panel having a plurality of openings thereon to accommodate two or more types of display fixtures;
a plurality of stationery products displayed on the two or more types of display fixtures, the plurality of stationery products being organized on the display panel by product type, occasion and product quality;
a plurality of display signs attached to the merchandise display which indicate the type of product located below each of the plurality of display signs.

16. The retail merchandise display of claim 15, wherein the type of the plurality of stationery products include invitations, thank you notes and blank note cards.

17. The retail merchandise display of claim 15, wherein each of the plurality of stationery products is contained within a product packaging.

18. The retail merchandise display of claim 17, wherein the product packaging may be a box with a transparent cover or a transparent bag with merchandise header.

19. The retail merchandise display of claim 18, wherein the plurality of stationery products which are contained within a box with transparent cover are located on shelves at a lower region of the display panel.

20. The retail merchandise display of claim 18, wherein the plurality of stationery products which are contained within a transparent bag with merchandise header are located on hanger hooks in an upper region of the display panel.
